(19) United States
(12) Patent Application Publication
(10) Pub. No.: US 2018/0131643 A1
(43) Pub. Date: May 10, 2018

(54) APPLICATION CONTEXT AWARE CHATBOTS

(71) Applicant: Microsoft Technology Licensing, LLC, Redmond, WA (US)

(72) Inventors: Adina Magdalena TRUFINESCU, Redmond, WA (US); Fatima KARDAR, Kirkland, WA (US); Matthew HIDINGER, Seattle, WA (US); Khuram SHAHID, Seattle, WA (US); Vishwac Sena KANNAN, Redmond, WA (US); Oscar E. MURILLO, Redmond, WA (US); Elan LEVY, Redmond, WA (US)

(73) Assignee: Microsoft Technology Licensing, LLC, Redmond, WA (US)

(21) Appl. No.: 15/632,217

(22) Filed: Jun. 23, 2017

Related U.S. Application Data
(60) Provisional application No. 62/418,085, filed on Nov. 4, 2016.

(51) Int. Cl. H04L 12/58; G06F 3/048; G06F 17/30

(52) U.S. Cl. CPC H04L 51/02; G06F 17/3043; G06F 3/048

(57) ABSTRACT

A computing device is provided, which may include a display, an input device and a processor configured to execute an application program including an application user interface presented via the display, the application user interface including a session state of a current session of a user, and execute a bot client program configured to execute a dialog with a user, the bot client program including a conversation canvas presented via the display, wherein the bot client program is configured to receive a query in the dialog from the user via the input device and conversation canvas, determine that the query is directed to content related to the state of the application program, send a context request to the application program, receive context data from the application program, the context data being derived from the state of the application program, and determine a response to the query.

### CROSS REFERENCE TO RELATED APPLICATIONS

This application claims priority to U.S. Provisional Patent Application No. 62/418,085 filed Nov. 4, 2016, the entirety of which is hereby incorporated herein by reference.

### BACKGROUND

Chatbots today are software programs that are built around a messaging paradigm in which a chat client program exchanges text, and in some cases visual cards, with a server-side chatbot program. Chatbot programs may be built, for example, by using a bot framework, such as the MICROSOFT Bot Framework. Chatbot programs developed with such a framework can be designed to send and receive messages with various user-side chat client programs. However, the utility of chatbots has generally been limited to communicating back and forth between the chatbot server and chatbot client program. Within this limited sphere of interaction, and given the imperfect nature of natural language processing technologies, challenges can arise in chatbot dialogs when the chatbot program does not understand or cannot answer user input.

### SUMMARY

A computing device to address at least the issues discussed above is provided. The computing device may include a display, an input device and a processor configured to execute an application program including an application user interface presented via the display, the application user interface including a session state of a current session of a user, and execute a bot client program configured to execute a dialog with a user, the bot client program including a conversation canvas presented via the display, wherein the bot client program is configured to receive a query in the dialog from the user via the input device and conversation canvas, determine that the query is directed to content related to the state of the application program, send a context request to the application program, receive context data from the application program, the context data being derived from the state of the application program, and determine a response to the query based on the context data from the application program and previous queries received from the user via the conversation canvas.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example computing system for facilitating chatbot dialogs, including a computing device according to an embodiment of the present description.

FIG. 2 shows an example user interface and conversation canvas using the computing system of FIG. 1.

FIG. 3 shows an example user interface and conversation canvas using the computing system of FIG. 1.

FIG. 4 shows an example method for facilitating chatbot dialogs.

FIG. 5 shows an example computing system according to an embodiment of the present description.

### DETAILED DESCRIPTION

The inventors have recognized certain limitations with current chatbot frameworks, namely that situations sometimes arise in which the chatbot cannot understand or answer user input, because the natural language processing logic of the chatbot lacks sufficient contextual information regarding the query. The inventors have realized that chatbots may be used in parallel with application programs by a user, and present herein a computing system that enables structured communication between a chatbot and an application program, so that contextual information from the application program may be communicated to and leveraged by the chatbot to process user queries with greater effectiveness, and so that the functionality of both the application program and chatbot may be extended.

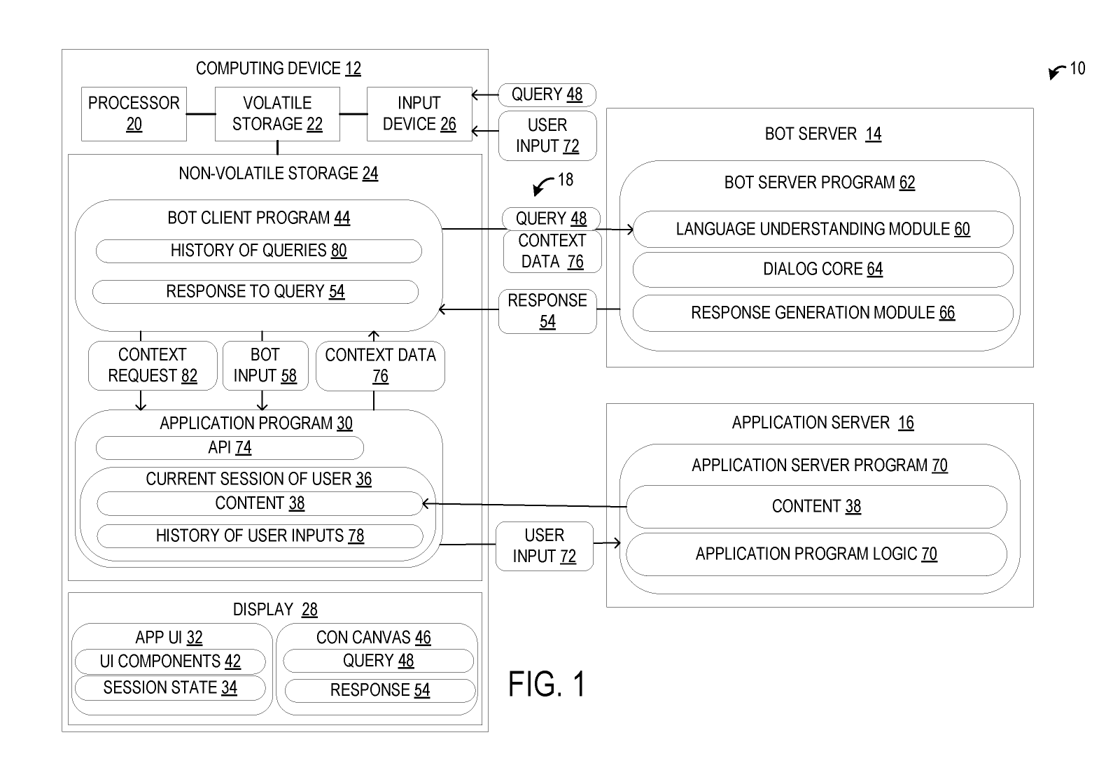

FIG. 1 illustrates an example computing system 10 according to one embodiment of the present disclosure. The computing system 10 includes a computing device 12, bot server 14, and application server 16. The bot server 14 and the application server 16 may each, for example, take the form of single server devices or multiple server devices operating in a cloud computing configuration. The bot server 14 and the application server 16 may be different server devices located in different locations. In one configuration, the bot server 14 and the application server 16 are implemented on the same server, or the same server system in a cloud computing configuration. The client computing device 12 may, for example, take the form of a desktop computing device, a smart display, a tablet computing device, a laptop computing device, or other suitable form of client computing device.

The computing device 12 may be configured to communicate via a communication network 18 with the bot server 14, and the application server 16. The communication network 18 may include, for example, a wide area network such as the Internet, Bluetooth networks, wired and wireless networks, etc.

As illustrated in FIG. 1, the computing device 12 may include a processor 20, volatile storage 22, non-volatile storage 24, an input device 26, and a display 28. The input device 26 may include several types of input devices, such as a microphone, a keyboard, a mouse, a capacitive touch input device, and other suitable input devices. In one configuration, the input device 26 may be integrated with the display 28, such as in a capacitive touch screen configuration. The processor 20 is configured to execute an application program 30 including an application user interface 32 presented via the display 28, the application user interface including a session state 34 of a current session 36 of a user. The current session 36 of the user may include content 38 that is displayed via the application user interface 32, various graphical user interface components, a history of user inputs 40 to the various graphical user interface components, and other state information that the application program 30 may use to generate the application user interface 32. The session state 34 may include a current state of the application user interface 32, such as currently shown content 38, viewable user interface components 42, etc. The user interface components 42 may include, for example, graphical selector components, a search bar component, a navigational component, and other types of suitable graphical user interface components that the user may apply input to affect the current session state 34 of the application user interface.

As illustrated in FIG. 1, the processor 20 is configured to execute a bot client program 44 configured to execute a dialog with a user, the bot client program 44 including a conversation canvas 46 presented via the display. The conversation canvas 46 may take the form of a graphical user interface that displays the dialog, including one or more queries 48 from the user, and one or more responses 50 determined by the bot client program 44. In one configuration, the bot client program 44 is a separate program executed separately from the application program 30. In another configuration, the bot client program 44 is a module of the application program 30 that is executed concurrently with the application program 30. In these configurations, the application user interface 32 and the conversation canvas 46 may be displayed concurrently, even when the bot client program 44 is executed as a separate program from the application program 30.

In one example, the application program 30 communicates with an application server 16 via a wide area network 18, and the bot client program 44 communicates with a bot server 14 via the wide area network 18, the bot server 14 and application server 16 being different servers. In one specific example, the chatbot of the bot client program 44 may be developed separately from the application program 30. Thus, application logic for the chatbot and the application program may be executed on different servers. In another specific example, the same developer may develop both the bot client program 44 and the application program 30 to communicate with a single server system configured to execute the functions of both the bot server 14 and the application server 16. The methods described herein provide a framework for facilitating an exchange of contextual data between the bot client program 44 and the application program 30 to allow both the bot client program 44 and the application program 30 to concurrently provide a response to user inputs to either of the programs.

As illustrated in FIG. 1, the bot client program 44 may be configured to communicate with the bot server 14 to determine a response 50 to a user query 48. In one example, the bot client program 44 sends a received user query 48 to the bot server 14. The bot server 14 may be configured to receive the user query 48, and perform analysis on the query 48 at a language understanding module 60 of a bot server program 62 executed on the bot server 14. The language understanding module 60 may be configured to perform keyword matching analysis to determine whether the query 48 of the user has a high degree of matching with a particular dialog flow stored in the dialog core 64 of the bot server program 62. The dialog flow may be a set of possible queries and responses that are generated by a developer of the bot client program 44. Thus, if the query 48 has a high degree of keyword matches with a stored dialog flow, the dialog core 64 of the bot server program 62 may be configured to output a response 54 according to the matched dialog flow. The response 54 may be generated by a response generation module 66 of the bot server program 62 executed by the bot server 14. The response generation module 66 may be configured to generate a text based response to be presented to the user via the conversation canvas 46. However, it will be appreciated that other suitable types of response 54 may also be generated, such as, for example, a programmatic input to the application program 30 to cause the application program 30 to display content 38 corresponding to the user query 48.

Additionally, the application program 30 may be configured to communicate with the application server 16 to retrieve content 38. The application server 16 may execute an application server program 68 that includes application program logic 70. As illustrated in FIG. 1, the application program 30 is configured to receive user input 72 to user interface components 42 of the application user interface 32 via the input device 26 of the computing device 12. For example, the user may click on a user interface component 42 via a mouse input device. The application program 30 is configured to receive the user input 72 to the user interface component 42, and sends the user input 72 to the application server 16. Based on at least receiving the user input 72, the application server program 70 executed by the application server 16 may be configured to serve content 38 to the application program 30 based on the application program logic 70 and the user input 72. Upon receiving the content 38 from the application server 16, the application program 30 is configured to present the content 38 via the application user interface 32 shown on the display 28.

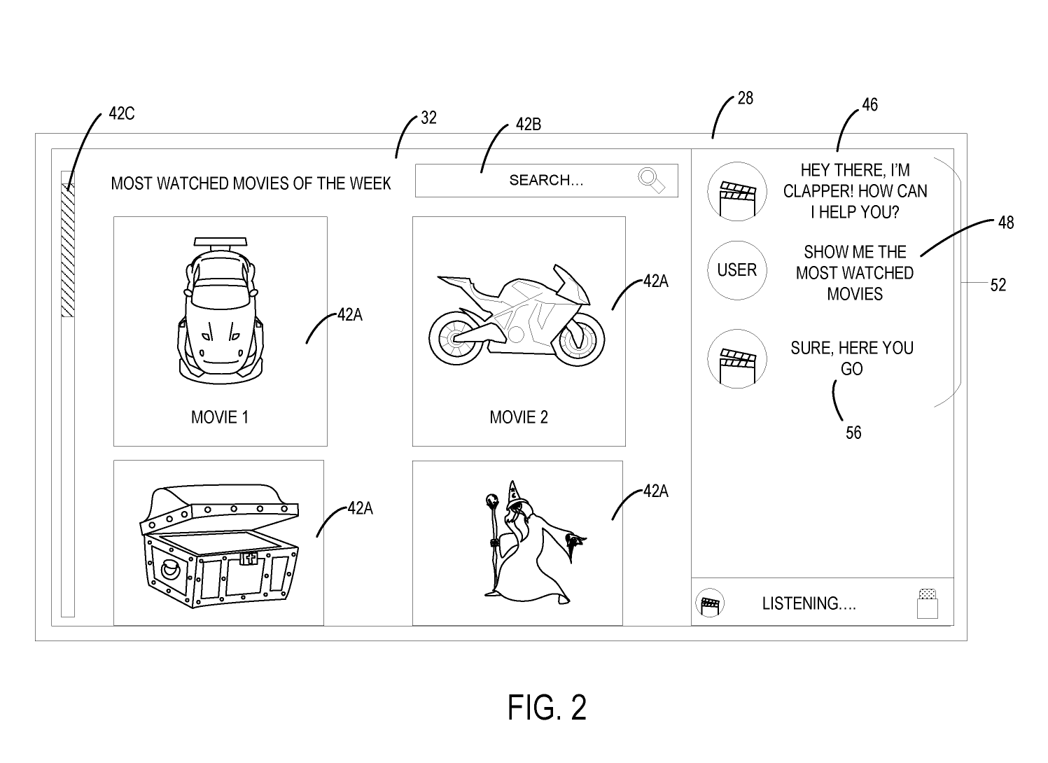

Turning to FIG. 2, an example application user interface 32 and example conversation canvas 46 is illustrated. In the illustrated example, the application user interface 32 and the conversation canvas 46 are presented concurrently via the display 28. Thus, the user may view and interact with both the application user interface 32 and the conversation canvas 46 at a same time. In this example, an example dialog 52 is presented via the conversation canvas 46 shown on the display 28. The bot client program initiated the example dialog 52 via the phrase “Hey there, I'm Clapper! How can I help you?” However, it will be appreciated that the dialog 52 may be initiated through other suitable methods, such as, for example, an initial input from the user to the conversation canvas. As another example, the example dialog 52 may be initiated through a trigger input from the user, such as, for example, “Hi Clapper.” These user inputs may be received by the computing device 12 via a suitable input device 26. For example, a text based user input may be received via a keyboard, and a voice based user input may be received via a microphone. However, it will be appreciated that other suitable input modalities may also be utilized, such as, for example, a virtual keyboard and a capacitive touch screen.

As illustrated in FIG. 2, the bot client program 44 is configured to receive a query 48 in the dialog 52 from the user via the input device 26 and conversation canvas 46. The query 48 may be received via an input device 26 suitable for the type of user input. In the illustrated example, the user may have input the query 48 via a microphone input device, and the client bot program 44 may be configured to listen for voice inputs from the user. However, it will be appreciated that the query 48 may be input via other suitable input modalities, such as, for example, text input via a physical or virtual keyboard, gesture inputs, selecting graphical user interface elements via a touch input, etc. Based on at least receiving the query 48 in the dialog 52 from the user, the bot client program 44 may be configured to display the query 48 as understood by the bot client program 44 on the conversation canvas 46. In this manner, the user may view the conversation canvas 46 to confirm that the bot client program understood the user's input accurately.

After receiving the query 48, the bot client program 44 executed by the processor 20 may be configured to attempt to resolve the query 48 to determine a response 54. The response 54 may include a text based response to the query 48 and a change in the application user interface 32 and the content 38 being displayed 28. In the example illustrated in FIG. 2, the user has input a query 48 that includes the phrase “Show me the most watched movies.” The bot client program 44 receives the query 48, and determines a response 54. In one configuration, the determined response 54 to the query 48 includes presenting a text response 56 to the query 48 via the conversation canvas 46. In the illustrated example, the example text response 56 includes a text phrase of “”Sure, here you go”, that is presented via the example dialog 52 of the conversation canvas 46 shown on the display 28. In this configuration, the determined response 54 to the query may further include programmatically sending a bot input 58 to the application program 30 that changes the session state 34 of the application program 30. In other examples, the text response 56 may include enhanced text such as emojis which may be encoded, for example, in a suitable format such as Unicode 5.0. The bot input 58 may take a form suitable for the application program 30. For example, the application program 30 may include a search bar, and the bot input 58 may be an input of the user's query 48 to the search bar of the application program 30. As another example, the application program 30 may include an application program interface that is accessible by the bot client program 44 that allows the bot client program 44 to input commands or data to the application program 30. In some examples, changing the session state 34 of the application user interface 32 of the application program 30 may include changing content 38 and user interface components 42 displayed via the application user interface 32.

In the example illustrated in FIG. 2, the determined response 54 includes both the text response 56 and a bot input 58 to the application program 30 that changes the session state 34 of the application program 30. In this specific example, the bot input 58 causes the application program 30 to present a list of the most watched movies of the week in response to the user query of “Show me the most watched movies.” In one configuration, the bot input 58 is determined by the bot client program 44 via keyword matching.

For example, the bot client program 44 may access an application program interface 74 of the application program 30, and determine that the application program includes a “most watched movies of the week” function. Thus, upon receiving the user query of “Show me the most watched movies”, the bot client program 44 may be configured to perform keyword matching to determine that a portion of the user query 48 of “most watched movies”, matches the application program's 30 “most watched movies of the week” function exposed by the application program's 30 application program interface 74. In the illustrated example, the determined response 54 to the query 48 includes programmatically sending a bot input 58 to the application program 30 that changes the session state 34 of the application program 30 to cause the application program 30 to show the most watched movies of the week via the application user interface 74. The change to the session state 34 of the current session 36 of the application program 39 may include presenting new content 38 comprising a plurality of movies via the application user interface 32. Thus, the response 54 of the bot client program 44 to the user query 48 may include both a test based response on the conversation canvas 46, as well was a change in the application user interface 32 and the displayed content 38 of an application program 30 executed on the computing device 12.

In one example, the session state 34 of the current session 36 of the application program 30 may be changed via user inputs 72 to user interface components 42 of the application user interface 32. In this example, the application program 30 is configured to receive a user input 72 to the application user interface 32 via the input device 26 that changes a session state 34 of the application program 30. In the example illustrated in FIG. 2, the application user interface 32 includes a plurality of user interface components 42. In one configuration, the user input 72 is selection of a graphical selector 42A displayed on the application user interface 32 of the application program 30. As shown, the application user interface 32 includes several graphical selector 42A user interface components that may be selected via a user input 72, such as, for example, a click input from a mouse input device, or a touch input from a capacitive touch sensor input device. It will be appreciated that the change in session state may be a change in user input 72, for example. The user input may be text input, or navigational input. For example, the user input may be navigational user input that changes the GUI element that currently has focus (i.e., is currently configured to receive keyboard or other input from a user input device), even if they GUI element is not yet selected in the sense of being clicked on. Alternatively, the change in session state may be a change in the displayed output of the application user interface 32, or may be combination of both a displayed set of GUI elements, and a user selection of one of those GUI elements, for example. Other examples are expounded upon below.

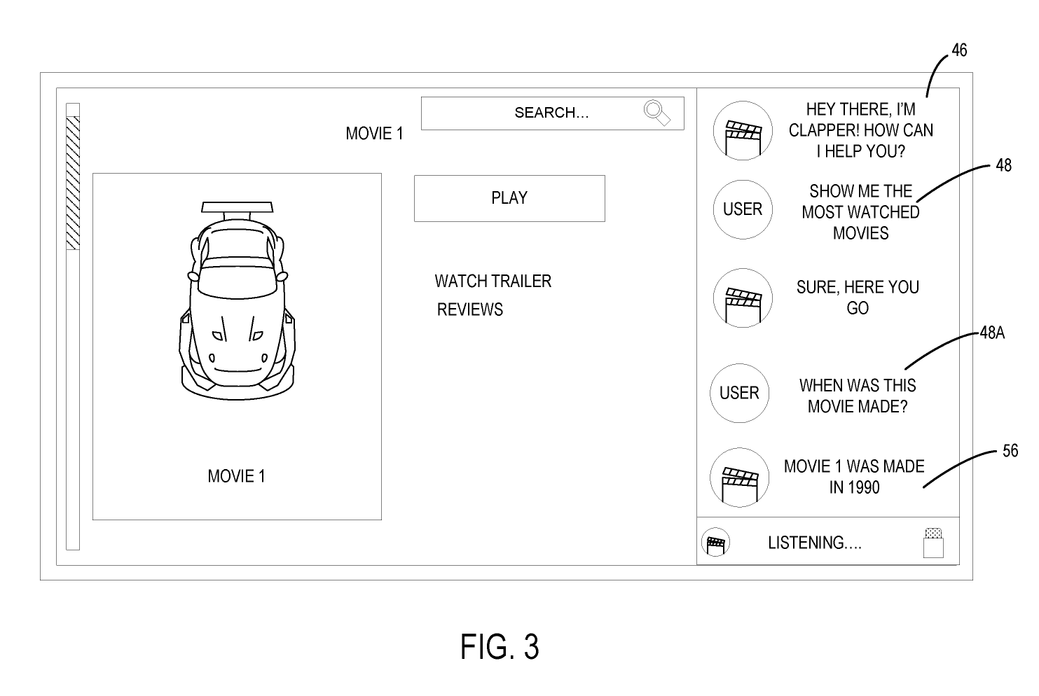

Upon receiving a user input 72 that is a selection of a graphical selector 42A, the application program 30 may be configured to present content 38 corresponding to the selected graphical selector 42A. In one example, the user may click on the graphical selector 42A for “MOVIE 1”. Upon receiving the user input 72, the application program 30 may send the user input 72 of the graphical selector 42A to the application server 16, which, based on the application program logic 70, may send back content 38 for “MOVIE 1”. The application program 30 may be configured to change the session state 34 of the application user interface 32 to display the received content 38 for “MOVIE 1”. Turning briefly to FIG. 3, the user has clicked on the graphical selector 42A for “MOVIE 1”, and the session state 34 of the application user interface 32 has changed to present specific content 38 for “MOVIE 1”, which includes additional options for the user such as watching a trailer for “MOVIE 1” or reading reviews for “MOVIE 1”.

In one specific example configuration, the user input 72 is entry of a search query via the application user interface of the application program. In the example illustrated in FIG. 2, the application user interface 32 includes a search bar 42B user interface component. In one example, the user may enter a user input 72 of a search query into the search bar 42B user interface component. The application program 30 may send the user input 72 of the search query to the application server 16, and the application server 16 may send back content 38 corresponding to the user input 72 of the search query. For example, if the user enters a search query for “MOVIE 1” into the search bar 42B, the application program 30 may be configured to change the session state 34 to present content 38 for “MOVIE 1” received from the application server 16, as shown in FIG. 3.

In another example configuration, the user input 72 is a navigation input into the application user interface 32 of the application program 30. In the example illustrated in FIG. 2, the application user interface 32 includes a scroll bar 42C user interface component. In one example, the user may enter a user input 72 of a scrolling navigation input to the scroll bar 42C, such as, for example, dragging the scroll bar 42C via a mouse input or scrolling a scroll wheel of a mouse input device 26. The application program 30 may be configured to change the session state 34 of the application program 30 to present content 38 that was previously hidden, but is now revealed after scrolling the application user interface 32 via the scroll bar 42C user interface component.

Based on at least changing the session state 34 via any of the methods described herein, the application program 30 may be configured to send context data 76 to the bot client program 44 including an updated context that is derived from the changed state 34 of the application program 30. The context data 76, may, for example, include the content 38 currently being displayed via the application user interface 32 of the application program 32. However, it will be appreciated that the context data 76 may include other types of data related to the session state 34 of the current session 36 of the application program 30. In one example, the session state 34 includes a history of user inputs 78 to the application user interface 32, and the context data 76 sent to the bot application program 44 may include the history of user inputs 78 to the user interface components 42 of the application user interface 32. In another example, the context data 76 may include other data, such as a profile for the user of the application program 30, user settings, a history of content 38 viewed by the user via the application program 30, etc.

By receiving the context data 76 from the application program 30, the bot client program 44 is configured to be contextually aware of the session state 34 of the application program 30, including a current state of the application user interface 32 and content 38 being presented by the application program 30. As illustrated in FIG. 1, the bot client program 44 may be configured to send the context data 76 received from the application program 30 to the bot server 14, which may be configured to determine the response 54 based on both the query 48 and the context data 76.

In one example, the bot client program 44 and the bot server 14 may be configured to determine the response 54 based on the received context data 76 and not in response to a query 48 from the user. For example, based on at least receiving context data 76 including an updated context that is derived from the changed session state 34 of the application program 30, the bot client program 44 may be configured to determine a response to the user input to the application user interface based on the context data from the application program 30. In this example, the determined response is not a response to a specific query from the user, but is rather a proactive response to user inputs to the application user interface 32. In one specific example, the determined response may include posting additional information or relevant resources to the conversation canvas 48 in response to the user entering a user input to select a user interface component of the application user interface 32.

Now turning to FIG. 3, in one example, the query 48 includes a word or phrase and the bot client program 44 is unable to resolve the meaning of the word or phrase with a threshold confidence level, and in response to determining that it is unable to do so, the bot client program 44 is configured to send a context request 76 to the application program 30. In the illustrated example, an example query 48A includes the phrase “When was this movie made?” In one example, the bot client program 44 may be configured to attempt to determine a response 54 to the example query 48A based on a history of queries 80 received from the user. For example, the bot client program 44 may send the example query 48A to the bot server 14, which is configured to determine a response 54 for the example query 48A. When attempting to resolve the phrase “this movie”, the response generation module 66 of the bot server program 62 may analyze past queries received from the client bot program 44 in a history of queries 80 for matching keywords. For example, if a previous query included the phrase “Show me MOVIE 1”, then the response generation module 66 may be configured to determine that the phrase “this movie” refers to “MOVIE 1”, and may be configured to determine the response 54 to the example query 48A based on “MOVIE 1”, and send the determined response 54 to the bot client program 44.

However, in the example illustrated in FIG. 3, the history of user queries 80 as shown in the conversation canvas 46 only includes the query 48 of “Show me the most watched movies.” Thus, the bot client program 44 is unable to resolve the meaning of the phrase “When was this movie made” with a threshold confidence level, as the bot client program 44 does not have the contextual data to determine which movie the phrase “this movie” refers.

In one configuration, in response to determining that it is unable resolve the meaning of the word or phrase of a query 48 with a threshold confidence level, the bot client program 44 is configured to determine whether the query 48 is directed to content 38 related to the session state 34 of the application program 30. For example, the bot client program 44 may perform keyword matching to determine whether the user query 48 is directed to content that is likely to be shown by the application program 30. In the example illustrated in FIG. 3, the bot client program 44 may be configured to determine that the phrase “When was this movie made” is directed to content related to the session state 34 of the application program 30, as previously received queries 48 in the history of queries 80 and previously received context data 76 includes words or phrases related to the keyword “movie”.

In one configuration, based on at least determining that the query 48 is directed to content 38 related to the session state 34 of the application program 30, the bot client program 44 may be configured to send a context request 82 to the application program 30. Based on at least receiving the context request 82 from the bot client program 44, the application program 30 may be configured to send current context data 76 for the session state 34 of the application user interface 32. The context data 76 may include the current content 38 being presented via the application user interface 32 of the application program 30, the history of user inputs 78, etc. Next, the bot client program 44 may be configured to receive context data 76 from the application program 30, the context data 76 being derived from the session state 34 of the application program 30, and determine a response 54 to the query 48 based on the context data 76 from the application program 30 and previous queries received from the user via the conversation canvas 48. As described herein, the bot client program 44 may be configured to send the query 48 and context data 76 to the bot server 14, which is configured to determine and send a response 54 back to the bot client program 44.

In the example illustrated in FIG. 3, the example query 48A of “When was this movie made?”, and context data 76 which may include the content 38 for “Movie 1” that is currently being presented by the application user interface, are sent by the bot client program 44 to the bot server 14. The response generation module 66 may resolve the example query 48A based on the context data 76, and send a determined response 54 to the bot client program 44. In the illustrated example, the determined response includes a text response 56 to the conversation canvas 46 of “Movie 1 was made in 1990”.

It will be appreciated that the above described systems and methods provide additional context to the chatbot to enable it to more effectively service the queries of users, and further extends the functionality of both the application program and chatbot by facilitating structured communication between the two.

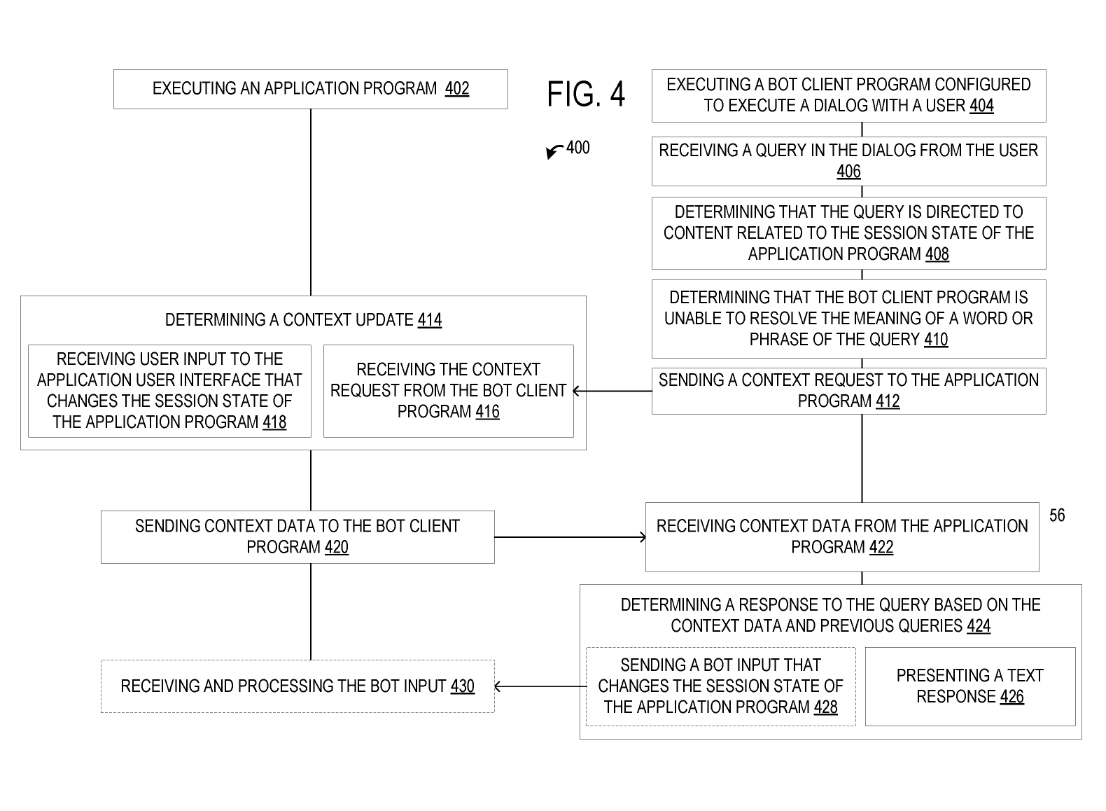

FIG. 4 shows an example computer-implemented method 400 according to an embodiment of the present disclosure. At step 402, the method 400 may include executing an application program including an application user interface presented via a display, the application user interface including a session state of a current session of a user. The current session 36 of the user may include content 38 that is displayed via the application user interface 32, various graphical user interface components, a history of user inputs 40 to the various graphical user interface components, and other state information that the application program 30 may use to generate the application user interface 32. The session state 34 may include a current state of the application user interface 32, such as currently shown content, viewable user interface components, etc., of the current session 36 for the application program.

At step 404, the method 400 may include executing a bot client program configured to execute a dialog with a user, the bot client program including a conversation canvas presented via the display. The conversation canvas 46 may take the form of a graphical user interface that displays the dialog, including one or more queries 48 from the user, and one or more responses 50 determined by the bot client program 44. In one configuration, the bot client program 44 is a separate program executed separately from the application program 30. In another configuration, the bot client program 44 is a module of the application program 30 that is executed concurrently with the application program 30. In these configurations, the application user interface 32 and the conversation canvas 46 may be displayed concurrently, even when the bot client program 44 is executed as a separate program from the application program 30.

In one example, the application program 30 communicates with an application server 16 via a wide area network 18, and the bot client program 44 communicates with a bot server 14 via the wide area network 18, the bot server 14 and application server 16 being different servers. In one specific example, the chatbot of the bot client program 44 may be developed separately from the application program 30. Thus, application logic for the chatbot and the application program may be executed on different servers. In another specific example, the same developer may develop both the bot client program 44 and the application program 30 to communicate with a single server system configured to execute the functions of both the bot server 14 and the application server 16.

While executing the bot client program, the method 400 proceeds to step 406 and may include receiving a query in the dialog from the user via the conversation canvas. In one example, the query may be entered by the user with a text based user input received via a keyboard. In another example, the query may be entered by the user with a voice based user input received via a microphone. However, it will be appreciated that other suitable input modalities may also be utilized, such as, for example, a virtual keyboard and a capacitive touch screen.

Advancing to step 408, the method 400 may include determining that the query is directed to content related to the state of the application program. For example, the bot client program may be configured to determine that the query includes keywords or phrases that are related to content presented by the application program. In one specific example, the query may include the keyword “movie”, and the bot client program may determine that the query is related to content presented by a movie application program.

Proceeding to step 410, the method 400 may include determining that the bot client program is unable to resolve the meaning of a word or phrase of the query with a threshold confidence level. For example, the query may include words or phrases that refer to content presented via the application program, and the bot client program may not currently have access to contextual data for that content. Without that contextual data, the bot client program may be unable to resolve such a query from the user.

In response to determining that the bot client program is unable to resolve the meaning of the word of phrase with a threshold confidence level, the method 400 advances to step 412 and includes sending a context request to the application program. The context request is a request for data related to the session state of the current session of the user for the application program, which may include, for example, content currently being presented to the user by the application program.

At the application program, the method 400 may include, at step 414, determining a context update for the bot client program including determining context data for the session state of the current session of the user to be sent to the bot client program. Step 414 may include two triggering conditions at steps 416 and 418 for determining to send context data to the bot client program.

At step 416, the method 400 may include receiving the context request from the bot client program 416. After receiving the context request, the application program may be configured to determine the context data for the session state of the current session of the user. Proceeding from step 416 to step 420, the method may include sending the context data to the bot client program.

At step 418, the method 400 may include receiving a user input to the application user interface that changes the session state of the application program. For example, the user may click on a user interface component 42 of the application user interface via a mouse input device. The application program 30 receives the user input 72 to the user interface component 42, and sends the user input 72 to the application server 16. Based on at least receiving the user input 72, the application server program 70 executed by the application server 16 may be configured to serve content 38 to the application program 30 based on the application program logic 70 and the user input 72. Upon receiving the content 38 from the application server 16, the application program 30 is configured to present the content 38 via the application user interface 32 shown on the display 28. In this manner, the application program changes content being displayed in response to a user input to the application user interface. As the session state (e.g. displayed content) has changed, the bot client program may now have outdated context data. Thus, the method 400 may advance to step 420 including sending context data to the bot client program including an updated context that is derived from the changed session state of the application program.

Proceeding from step 420 to step 422, the method 400 may include receiving context data from the application program, the context data being derived from the session state of the application program. The context data 76, may, for example, include the content 38 currently being displayed via the application user interface 32 of the application program 32. However, it will be appreciated that the context data 76 may include other types of data related to the session state 34 of the current session 36 of the application program 30. In one example, the session state 34 includes a history of user inputs 78 to the application user interface 32, and the context data 76 sent to the bot application program 44 may include the history of user inputs 78 to the user interface components 42 of the application user interface 32. In another example, the context data 76 may include other data, such as a profile for the user of the application program 30, user settings, a history of content 38 viewed by the user via the application program 30, etc.

Advancing from step 422 to step 424, the method 400 may include determining a response to the query based on the context data from the application program and previous queries received from the user via the conversation canvas. In one example, the bot client program 44 sends a received user query 48 and the received context data to the bot server 14. The bot server 14 may be configured to receive the user query 48 and the context data, and perform analysis on the query 48 at a language understanding module 60 of a bot server program 62 executed on the bot server 14. Based on the analysis on the query 48 and the context data, the bot server program 62 may determine a response to the query, and send the response to the bot client program.

In one example, step 424 may include steps 426 and 428. At step 426, the method 400 may include presenting a text response to the query via the conversation canvas. The bot client program may add the text response to the dialog with the user that is presented via the displayed conversation canvas of the bot client program.

At step 428, the method may include programmatically sending a bot input to the application program that changes the session state of the application program. For example, the bot client program 44 may access an application program interface 74 of the application program 30 and determine that an accessible function in the application program interface 74 is related to the query entered by the user. In one specific example, the bot input 58 may cause the application program 30 to present a list of the most watched movies of the week in response to the user query of “Show me the most watched movies.”

At step 430, the method 400 may include receiving the bot input at the application program, and changing the session state of the current session of the user for the application program based on the bot input.

In some embodiments, the methods and processes described herein may be tied to a computing system of one or more computing devices. In particular, such methods and processes may be implemented as a computer-application program or service, an application-programming interface (API), a library, and/or other computer-program product.

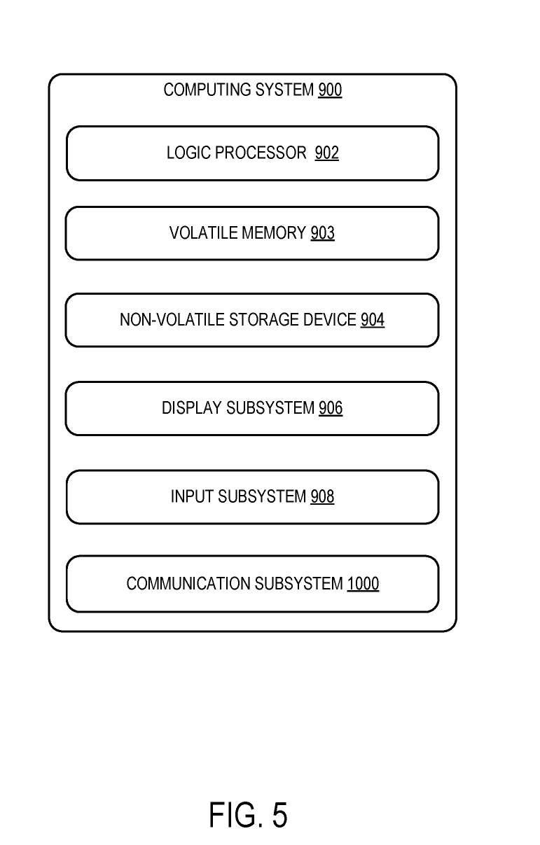

FIG. 5 schematically shows a non-limiting embodiment of a computing system 900 that can enact one or more of the methods and processes described above. Computing system 900 is shown in simplified form. Computing system 900 may embody one or more of the computing device 12, the bot server 14, and the application server 16 of FIG. 1. Computing system 900 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 900 includes a logic processor 902 volatile memory 903, and a non-volatile storage device 904. Computing system 900 may optionally include a display subsystem 906, input subsystem 908, communication subsystem 1000, and/or other components not shown in FIG. 5.

Logic processor 902 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 902 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 904 includes one or more physical devices configured to hold instructions executable by the logic processors to implement the methods and processes described herein. When such methods and processes are implemented, the state of non-volatile storage device 94 may be transformed—e.g., to hold different data.

Non-volatile storage device 904 may include physical devices that are removable and/or built-in. Non-volatile storage device 94 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 904 may include nonvolatile, dynamic, static, read/write, read-only, sequential-access, location-addressable, file-addressable, and/or content-addressable devices. It will be appreciated that non-volatile storage device 904 is configured to hold instructions even when power is cut to the non-volatile storage device 904.

Volatile memory 903 may include physical devices that include random access memory. Volatile memory 903 is typically utilized by logic processor 902 to temporarily store information during processing of software instructions. It will be appreciated that volatile memory 903 typically does not continue to store instructions when power is cut to the volatile memory 903.

Aspects of logic processor 902, volatile memory 903, and non-volatile storage device 904 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 900 typically implemented in software by a processor to perform a particular function using portions of volatile memory, which function involves transformative processing that specially configures the processor to perform the function. Thus, a module, program, or engine may be instantiated via logic processor 902 executing instructions held by non-volatile storage device 904, using portions of volatile memory 903. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 906 may be used to present a visual representation of data held by non-volatile storage device 904. The visual representation may take the form of a graphical user interface (GUI). As the herein described methods and processes change the data held by the non-volatile storage device, and thus transform the state of the non-volatile storage device, the state of display subsystem 906 may likewise be transformed to visually represent changes in the underlying data. Display subsystem 906 may include one or more display devices utilizing virtually any type of technology. Such display devices may be combined with logic processor 902, volatile memory 903, and/or non-volatile storage device 904 in a shared enclosure, or such display devices may be peripheral display devices.

When included, input subsystem 908 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 1000 may be configured to communicatively couple various computing devices described herein with each other, and with other devices. Communication subsystem 1000 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 900 to send and/or receive messages to and/or from other devices via a network such as the Internet.

The following paragraphs provide additional support for the claims of the subject application. One aspect provides a computing device comprising a display, an input device, and a processor configured to execute an application program including an application user interface presented via the display, the application user interface including a session state of a current session of a user, and execute a bot client program configured to execute a dialog with a user, the bot client program including a conversation canvas presented via the display, wherein the bot client program is configured to receive a query in the dialog from the user via the input device and conversation canvas, determine that the query is directed to content related to the session state of the application program, send a context request to the application program, receive context data from the application program, the context data being derived from the session state of the application program, and determine a response to the query based on the context data from the application program and previous queries received from the user via the conversation canvas. In this aspect, additionally or alternatively, the application program may communicate with an application server via a wide area network, and the bot client program may communicate with a bot server via the wide area network, the bot server and application server being different servers. In this aspect, additionally or alternatively, the application program and bot client program may communicate with a same server via a wide area network. In this aspect, additionally or alternatively, the application user interface and the conversation canvas may be presented concurrently via the display. In this aspect, additionally or alternatively, the application program may be configured to receive a user input to the application user interface via the input device that changes the session state of the application program, and send context data to the bot client program including an updated context that is derived from the changed session state of the application program. In this aspect, additionally or alternatively, the user input may be selection of a graphical selector displayed on the application user interface of the application program. In this aspect, additionally or alternatively, the user input may be entry of a search query via the application user interface of the application program. In this aspect, additionally or alternatively, the user input may be a navigation input into the application user interface of the application program. In this aspect, additionally or alternatively, the session state of the application program may include a history of user inputs to the user interface. In this aspect, additionally or alternatively, the query may include a word or phrase and the bot client program may be unable to resolve the meaning of the word or phrase with a threshold confidence level, and in response to determining that it is unable to do so, the bot client program may be configured to send the context request to the application program. In this aspect, additionally or alternatively, the determined response to the query may include presenting a text response to the query via the conversation canvas. In this aspect, additionally or alternatively, the determined response to the query may include programmatically sending a bot input to the application program that changes the session state of the application program.

Another aspect provides a method comprising executing via a processor of a computing device an application program including an application user interface presented via a display, the application user interface including a session state of a current session of a user, and executing a bot client program configured to execute a dialog with a user, the bot client program including a conversation canvas presented via the display, executing the bot client program including receiving a query in the dialog from the user via the conversation canvas, determining that the query is directed to content related to the session state of the application program, sending a context request to the application program, receiving context data from the application program, the context data being derived from the session state of the application program, and determining a response to the query based on the context data from the application program and previous queries received from the user via the conversation canvas. In this aspect, additionally or alternatively, the application program may communicate with an application server via a wide area network, and the bot client program may communicate with a bot server via the wide area network, the bot server and application server being different servers. In this aspect, additionally or alternatively, the application user interface and the conversation canvas may be presented concurrently via the display. In this aspect, additionally or alternatively, the method may include receiving a user input to the application user interface that changes the session state of the application program, and sending context data to the bot client program including an updated context that is derived from the changed session state of the application program. In this aspect, additionally or alternatively, the query may include a word or phrase and the bot client program may be unable to resolve the meaning of the word or phrase with a threshold confidence level, and in response to determining that the bot client program is unable to do so, the method may further include sending the context request to the application program. In this aspect, additionally or alternatively, the determined response to the query may include presenting a text response to the query via the conversation canvas. In this aspect, additionally or alternatively, the determined response to the query may include programmatically sending a bot input to the application program that changes the session state of the application program.

Another aspect provides a computing device, comprising a display, an input device, and a processor configured to execute an application program including an application user interface presented via the display, the application user interface including a session state of a current session of a user, execute a bot client program configured to execute a dialog with a user, the bot client program including a conversation canvas presented via the display, at the application program receive a user input to the application user interface via the input device that changes the session state of the application program, and send context data to the bot client program including an updated context that is derived from the changed session state of the application program, at the bot client program, receive the context data from the application program, and determine a response to the user input to the application user interface based on the context data from the application program.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A computing device, comprising:
a display;
an input device; and
a processor configured to:
execute an application program including an application user interface presented via the display, the application user interface including a session state of a current session of a user; and
execute a bot client program configured to execute a dialog with a user, the bot client program including a conversation canvas presented via the display, wherein the bot client program is configured to:
receive a query in the dialog from the user via the input device and conversation canvas;
determine that the query is directed to content related to the session state of the application program;
send a context request to the application program;
receive context data from the application program, the context data being derived from the session state of the application program; and
determine a response to the query based on the context data from the application program and previous queries received from the user via the conversation canvas.

2. The computing device of claim 1, wherein
the application program communicates with an application server via a wide area network; and
the bot client program communicates with a bot server via the wide area network, the bot server and application server being different servers.

3. The computing device of claim 1, wherein
the application program and bot client program communicate with a same server via a wide area network.

4. The computing device of claim 1, wherein the application user interface and the conversation canvas are presented concurrently via the display.

5. The computing device of claim 1, wherein the application program is configured to:
receive a user input to the application user interface via the input device that changes the session state of the application program; and
send context data to the bot client program including an updated context that is derived from the changed session state of the application program.

6. The computing device of claim 5, wherein the user input is selection of a graphical selector displayed on the application user interface of the application program.

7. The computing device of claim 5, wherein the user input is entry of a search query via the application user interface of the application program.

8. The computing device of claim 5, wherein the user input is a navigation input into the application user interface of the application program.

9. The computing device of claim 5, wherein the session state of the application program includes a history of user inputs to the user interface.

10. The computing device of claim 1, wherein the query includes a word or phrase and the bot client program is unable to resolve the meaning of the word or phrase with a threshold confidence level, and in response to determining that it is unable to do so, the bot client program is configured to send the context request to the application program.

11. The computing device of claim 1, wherein the determined response to the query includes presenting a text response to the query via the conversation canvas.

12. The computing device of the claim 1, wherein the determined response to the query includes programmatically sending a bot input to the application program that changes the session state of the application program.

13. A method comprising:
executing via a processor of a computing device an application program including an application user interface presented via a display, the application user interface including a session state of a current session of a user; and
executing a bot client program configured to execute a dialog with a user, the bot client program including a conversation canvas presented via the display, executing the bot client program including:
receiving a query in the dialog from the user via the conversation canvas;
determining that the query is directed to content related to the session state of the application program;
sending a context request to the application program;
receiving context data from the application program, the context data being derived from the session state of the application program; and
determining a response to the query based on the context data from the application program and previous queries received from the user via the conversation canvas.

14. The method of claim 13, wherein
the application program communicates with an application server via a wide area network; and
the bot client program communicates with a bot server via the wide area network, the bot server and application server being different servers.

15. The method of claim 13, wherein the application user interface and the conversation canvas are presented concurrently via the display.

16. The method of claim 13, further including:
receiving a user input to the application user interface that changes the session state of the application program; and
sending context data to the bot client program including an updated context that is derived from the changed session state of the application program.

17. The method of claim 13, wherein the query includes a word or phrase and the bot client program is unable to resolve the meaning of the word or phrase with a threshold confidence level, and in response to determining that the bot client program is unable to do so, the method further includes sending the context request to the application program.

18. The method of claim 13, wherein the determined response to the query includes presenting a text response to the query via the conversation canvas.

19. The method of the claim 13, wherein the determined response to the query includes programmatically sending a bot input to the application program that changes the session state of the application program.

20. A computing device, comprising:
a display;
an input device; and
a processor configured to:
execute an application program including an application user interface presented via the display, the application user interface including a session state of a current session of a user;
execute a bot client program configured to execute a dialog with a user, the bot client program including a conversation canvas presented via the display;
at the application program:
receive a user input to the application user interface via the input device that changes the session state of the application program; and
send context data to the bot client program including an updated context that is derived from the changed session state of the application program;
at the bot client program:
receive the context data from the application program; and
determine a response to the user input to the application user interface based on the context data from the application program.
